(19) United States
(12) Patent Application Publication
(10) Pub. No.: US 2026/0346246 A1
(43) Pub. Date: Nov. 5, 2026

(54) MICROFLUIDIC CHIP AND ITS USAGE METHOD, AND ITS CORRESPONDING MICROFLUIDIC SYSTEM AND MANUFACTURING METHOD OF CONDUCTIVE COVER PLATE

(71) Applicant: DIGIFLUIDIC BIOTECH LTD., Zhuhai (CN)

(72) Inventors: Tianlan CHEN, Zhuhai (CN); Chenghai LIU, Zhuhai (CN); Zheng WU, Zhuhai (CN); Xiangjun WU, Zhuhai (CN); Meixian LIANG, Zhuhai (CN); Kexuan CHENG, Zhuhai (CN)

(73) Assignee: DIGIFLUIDIC BIOTECH LTD., Zhuhai (CN)

(21) Appl. No.: 19/120,239

(22) PCT Filed: Oct. 11, 2023
(86) PCT No.: PCT/CN2023/124095

§ 371 Date: Apr. 11, 2025

(30) Foreign Application Priority Data
Oct. 12, 2022 (CN) 202211247595.1
Oct. 12, 2022 (CN) 202222690774.4
Jul. 11, 2023 (CN) 202310848619.7

(51) Int. Cl. B01L 3/00

(52) U.S. Cl. CPC B01L 3/502715; B01L 2200/0647; B01L 2300/041; B01L 2300/0645; B01L 2300/165; B01L 2300/1805; B01L 2400/043; B01L 2400/06

(57) ABSTRACT

Provided are a microfluidic chip and a usage method therefor, a microfluidic system, and a manufacturing method for a conductive cover plate. The chip includes an extraction assembly and an amplification assembly. The extraction assembly includes a lysis chamber, a first valve chamber, washing chambers, and a second valve chamber that sequentially connect with each other. The amplification assembly includes a chip substrate, a barrier layer, and a conductive cover plate. The barrier layer, the chip substrate, and the conductive cover plate form an elution chamber, a liquid path chamber, and an amplification chamber. A side of the conductive cover plate adjacent to the chip substrate is provided with a cavity having an opening at a bottom, and the elution chamber contains the cavity. The cavity has a thickness of 0.6 mm to 2 mm in a thickness direction of the microfluidic chip.

### CROSS-REFERENCE TO THE RELATED APPLICATIONS

This application is the national phase entry of International Application No. PCT/CN2023/124095, filed on Oct. 11, 2023, which is based upon and claims priority to Chinese Patent Application No. 202211247595.1 filed on Oct. 12, 2022, Chinese Patent Application No. 202222690774.4 filed on Oct. 12, 2022, and Chinese Patent Application No, 202310848619.7 filed on Jul. 11, 2023, the entire contents of which are incorporated herein by reference.

### TECHNICAL FIELD

The present invention relates to the field of microfluidic technologies, and in particular, to a microfluidic chip and its usage method, and its corresponding microfluidic system and manufacturing method of conductive cover plate.

### BACKGROUND

Digital microfluidics (DMF) is a branch technology in the field of microfluidics, and can control a single droplet with a size ranging from microliters to nanoliters. Digital microfluidic technology based on electrowetting-on-dielectric (EWOD) can manipulate individual droplets on an electrode array through electrowetting forces. Its electrically driven ability and small footprint make it a promising technology for point-of-care diagnostics.

There are two types of PCR methods in a digital microfluidic system. One is stationary droplet PCR, and the other is shuttling droplet PCR. In the stationary droplet PCR experiment, PCR droplets stay on an electrode for in-situ PCR, and the thermal cycle of PCR is implemented by controlling the heating time. The heater can be a large external heater for heating and cooling an entire chip, or an on-chip heater with a small heating volume. In the real-time qualitative and quantitative processes using PCR methods within microfluidic systems, there are two key requirements: firstly, the reagents need to be heated to 95 °C; secondly, most PCR methods utilize fluorescence method, which necessitates the cooperation of an optical module. At this temperature, the reagent is very likely to evaporate and generate bubbles, which affects the reagent's morphology, making it impossible to read the amplification curve from the reagent.

An existing microfluidic chip includes a conductive cover plate and a chip substrate. A TEFLON hydrophobic layer is arranged on a side of the conductive cover plate toward the chip substrate, and an expanded PTFE film is arranged on a side of the chip substrate toward the conductive cover plate, to reduce or avoid bubbles generated during amplification reaction on the microfluidic chip. However, this method is not suitable for mass production because of high costs and relatively complex to manufacture.

There is also an existing microfluidic chip where a hydrophilic layer is coated on the side of the conductive cover plate toward the chip substrate, and a hydrophobic layer is correspondingly arranged on the side of the chip substrate toward the conductive cover plate. However, once bubbles are generated in this setup, the reagent of sample is easily pushed away by the generated bubbles. This leads to movement of the reagent of sample and hinders observation.

An existing integrated microfluidic chip includes a lysis chamber, a washing chamber, an elution chamber, a liquid path chamber, and an amplification chamber that sequentially connected with each other. A lysis solution is prestored in the lysis chamber, and a washing solution is prestored in the washing chamber. An eluent is prestored in the elution chamber. Barriers such as paraffin valves are usually used between the elution chamber and the liquid path chamber for separation, and usually no electrode array is arranged on the substrate right under the elution chamber. However, a storage manner of the eluent for the microfluidic chip is relatively troublesome. Since it takes time for the paraffin valves to be sequentially heated and melted, detection efficiency is low. In addition, usually no electrode array is arranged on the substrate right under the elution chamber, and consequently it is impossible to move all eluted sample droplets into the liquid path chamber, resulting in inaccurate sample detection.

To move all the eluted sample droplets into the liquid path chamber, currently, there are further some microfluidic chips in which an air pump or gravity is usually used to move the sample droplets into the liquid path chamber. The operation by the air pump or the gravity is relatively troublesome and complex, and the latter cannot be used for a more refined operation, such as liquid separation.

An existing microfluidic chip includes a liquid storage electrode, a liquid separation electrode, and a liquid fixation electrode that are sequentially adjacent to each other. The liquid storage electrode has a width greater than that of the liquid fixation electrode, and the liquid separation electrode has a width less than that of the liquid fixation electrode. Before liquid separation, the sample droplets cover the entire liquid storage electrode and part of the liquid separation electrode. During liquid transportation, the liquid separation electrode is energized first, and the sample droplets occupy most of the liquid storage electrode, cover the liquid separation electrode, and occupy most of the liquid fixation electrode. In this case, the liquid separation electrode is turned off, and the liquid storage electrode and the liquid fixation electrode are both energized, so that the sample droplets split rapidly. Finally, the liquid storage electrode and the liquid fixation electrode are turned off. In this case, the droplets separated from the liquid storage electrode are located on the liquid fixation electrode. However, when this method is used to separate the sample droplets, during power-off of the liquid separation electrode, there is a too large volume of the sample droplets on the liquid separation electrode, and the droplets are split slowly during liquid separation. As a result, uneven splitting of the droplets easily occurs, and consequently there are insufficient droplets on the liquid fixation electrode, failing to meet test requirements, or there are excessive droplets on the liquid fixation electrode, affecting the accuracy of experiment.

### SUMMARY

### Technical Problems

A first objective of the present invention is to provide a microfluidic chip that stores and moves an eluent conveniently, can increase detection efficiency, and can fully move sample droplets in an elution chamber into a liquid path chamber.

A second objective of the present invention is to provide a microfluidic chip that can split sample droplets evenly and accurately during liquid separation.

A third objective of the present invention is to provide a microfluidic chip that reduces the impact of bubbles on detection result during the PCR process.

A fourth objective of the present invention is to provide a manufacturing method for a conductive cover plate, which is applied to the above-mentioned microfluidic chip.

A fifth objective of the present invention is to provide a usage method for the above-mentioned microfluidic chip.

A sixth objective of the present invention is to provide a microfluidic system including the above-mentioned microfluidic chip.

### Technical Solutions

To achieve the above-mentioned first objective, the microfluidic chip according to the present invention includes an extraction assembly and an amplification assembly, where the extraction assembly includes a lysis chamber, a first valve chamber, a washing chamber, and a second valve chamber that sequentially connect with each other; the amplification assembly includes a chip substrate, a barrier layer, and a conductive cover plate; the barrier layer is located between the chip substrate and the conductive cover plate, the barrier layer, the chip substrate, and the conductive cover plate form an elution chamber, a liquid path chamber, and an amplification chamber that sequentially connect with each other, and the elution chamber connect with the second valve chamber through the first channel; an electrode array is arranged on the chip substrate; a side of the conductive cover plate adjacent to the chip substrate is provided with a cavity having an opening at a bottom, and the elution chamber contains the cavity; the electrode array is located right under the elution chamber, the liquid path chamber, and the amplification chamber; the amplification assembly further includes a storage chamber for storing a surfactant, and the storage chamber connect with the elution chamber through a second channel; the liquid path chamber includes a liquid storage chamber, and the liquid storage chamber is adjacent to the elution chamber; and the cavity has a thickness of 0.6 mm to 2 mm in a thickness direction of the microfluidic chip.

In a further solution, the electrode array includes an elution electrode region and a first liquid storage electrode region that are adjacent to each other, the elution electrode region includes at least one elution electrode, viewing on the projection of the chip substrate, the elution electrode is located in the elution chamber; and the first liquid storage electrode region includes a first transition electrode and a first liquid storage electrode group that are adjacent to each other, viewing on the projection of the chip substrate, the first transition electrode spans across both the elution chamber and the liquid storage chamber, the first transition electrode is located between the elution electrode region and the first liquid storage electrode group, and the first liquid storage electrode group is located in the liquid storage chamber.

In a further solution, the first liquid storage electrode group includes at least two first liquid storage electrodes, a plurality of first liquid storage electrodes are sequentially arranged in a direction from the elution chamber to the liquid path chamber, an area of a current first liquid storage electrode is greater than that of a previous first liquid storage electrode, and the previous first liquid storage electrode is closer to the first transition electrode than the current first liquid storage electrode.

In a further solution, each first liquid storage electrode includes a first side edge and a second side edge that extend in a direction from the elution chamber to the liquid path chamber, the first side edge and the second side edge are opposite to each other, and a width between the first side edge and the second side edge of the current first liquid storage electrode is greater than that between the first side edge and the second side edge of the previous first liquid storage electrode.

In a further solution, the first side edges of all the first liquid storage electrodes are collinearly arranged, and the second side edges of all the first liquid storage electrodes are collinearly arranged.

In a further solution, the first transition electrode and the first liquid storage electrode adjacent to the first transition electrode have first arc-shaped portions that are embedded with each other, and an opening of each first arc-shaped portion faces the first transition electrode; and two adjacent first liquid storage electrodes have second arc-shaped portions that are embedded with each other, and an opening of each second arc-shaped portion faces the first transition electrode.

In a further solution, at least one first arc-shaped segment is arranged in the first arc-shaped portion, and an opening of the first arc-shaped segment faces away from the first transition electrode; and at least one second arc-shaped segment is arranged in the second arc-shaped portion, and an opening of the second arc-shaped segment faces away from the first transition electrode.

In a further solution, the conductive cover plate includes a plate body and a cover body; and a top of the cavity is provided with an opening of the plate, and the cover body covers the top opening of the cavity on the plate.

To achieve the above-mentioned second objective, the microfluidic chip according to this solution includes an amplification assembly, where the amplification assembly includes a chip substrate, a barrier layer, and a conductive cover plate; the chip substrate is arranged opposite to the conductive cover plate; the chip substrate includes a substrate plate, an electrode array, and an insulating layer, the electrode array is located on the substrate plate, and the insulating layer covers the electrode array and is adjacent to the conductive cover plate; the barrier layer is located between the chip substrate and the conductive cover plate, an accommodating portion is formed among the barrier layer, the chip substrate, and the conductive cover plate, and the electrode array corresponds to the accommodating portion; the electrode array includes a second liquid storage electrode region, a liquid separation electrode region, and a liquid fixation electrode region that are sequentially adjacent to each other; a width of the liquid fixation electrode region and a width of the second liquid storage electrode region are both greater than that of the liquid separation electrode region; the liquid fixation electrode region includes at least one liquid fixation electrode; the second liquid storage electrode region includes at least one second liquid storage electrode; the liquid separation electrode region includes a liquid separation portion, and the liquid separation portion includes a first electrode and a second electrode that are adjacently arranged in a width direction of the liquid separation portion; and an area of the second electrode is less than that of the liquid fixation electrode.

In a further solution, the liquid separation electrode region further includes a transportation portion, the transportation portion includes at least one transportation electrode, and the transportation portion is located between the liquid separation portion and the second liquid storage electrode region.

In a further solution, a width direction of the liquid fixation electrode intersects a width direction of the transportation portion, a width direction of a first end of the liquid separation portion is parallel to the width direction of the transportation portion, the first end of the liquid separation portion is adjacent to the transportation portion, a width direction of a second end of the liquid separation portion is parallel to a width direction of the liquid fixation electrode region, and the second end of the liquid separation portion is adjacent to the liquid fixation electrode region.

In a further solution, the width direction of the liquid fixation electrode region is perpendicular to the width direction of the transportation portion.

In a further solution, the second liquid storage electrode region includes two or more sequentially adjacent second liquid storage electrodes, two adjacent second liquid storage electrodes have first arc-shaped edge portions that are embedded with each other, and an opening of each first arc-shaped edge portion faces the liquid separation electrode region; and the liquid fixation electrode region includes two or more sequentially adjacent liquid fixation electrodes, two adjacent liquid fixation electrodes have second arc-shaped edge portions that are embedded with each other, and an opening of each second arc-shaped edge portion faces the liquid separation electrode region.

In a further solution, a third arc-shaped edge portion is arranged in the first arc-shaped edge portion, and an opening of the third arc-shaped edge portion faces away from the liquid separation electrode region; and a fourth arc-shaped edge portion is arranged in the second arc-shaped edge portion, and an opening of the fourth arc-shaped edge portion faces away from the liquid separation electrode region.

In a further solution, an area of the first electrode is greater than that of the second electrode.

In a further solution, a shape of the second electrode includes an isosceles triangle, a hypotenuse of the second electrode is adjacent to the first electrode, and the transportation portion and the liquid fixation electrode region are adjacent to two right-angled sides of the second electrode, respectively.

In a further solution, the second liquid storage electrode region further includes two second transition electrodes, a transportation electrode adjacent to the second liquid storage electrode is located between the two second transition electrodes, and each second transition electrode is adjacent to both the second liquid storage electrode and the transportation electrode.

In a further solution, the liquid separation portion includes a first toothed portion, a second toothed portion, and a third toothed portion; the first toothed portion is located at an edge of the liquid separation portion adjacent to the liquid fixation electrode region and is embedded in the edge of the liquid fixation electrode region; the second toothed portion is located at an edge of the liquid separation portion adjacent to the transportation portion and is embedded in the edge of the transportation portion; and the third toothed portion is located at an edge of the second electrode adjacent to the first electrode and is embedded in the first electrode.

To achieve the above-mentioned third objective, the microfluidic chip according to the present invention includes an amplification assembly, where the amplification assembly includes a chip substrate, a conductive cover plate, a barrier layer, and a first hydrophobic layer; the first hydrophobic layer is located on a side of the insulating layer oriented towards the conductive cover plate; the chip substrate is arranged opposite to the conductive cover plate; the chip substrate includes a substrate plate, an electrode array, and an insulating layer; the electrode array is located on the substrate plate, and the insulating layer covers the electrode array; the barrier layer is located between the chip substrate and the conductive cover plate; a liquid path chamber and an amplification chamber that connect with each other are formed by the barrier layer, the chip substrate, and the conductive cover plate; and the liquid path chamber and the amplification chamber are arranged corresponding to the electrode array; the conductive cover plate includes a liquid path region and an amplification region that are connected to each other, the liquid path region corresponds to the liquid path chamber, and the amplification region corresponds to the amplification chamber; the amplification assembly further includes a second hydrophobic layer and a hydrophilic layer that are adjacent to each other; the hydrophilic layer is located on a side of the amplification region adjacent to the chip substrate; and the second hydrophobic layer is located on a side of the liquid path region adjacent to the chip substrate, and the second hydrophobic layer and the hydrophilic layer are arranged opposite to the first hydrophobic layer.

In a further solution, the barrier layer includes a mixture of glue and plastic beads, and a distance between the chip substrate and the conductive cover plate is equal to a diameter of the plastic bead.

In a further solution, a ratio of a density of the glue to a density of the plastic beads is greater than or equal to 95%.

In a further solution, the microfluidic chip includes an extraction assembly, where the extraction assembly connects with the amplification assembly; the extraction assembly includes a lysis chamber, a washing chamber, and an elution chamber that sequentially connect with each other; the lysis chamber, the washing chamber, and the elution chamber are separated through paraffin valves; and the microfluidic chip further includes a heating unit arranged in the chip substrate, the heating unit includes a first heating wire and a second heating wire that are arranged in the substrate plate, the first heating wire corresponds to the paraffin valve, and the second heating wire corresponds to the amplification chamber.

To achieve the above-mentioned fourth objective, the manufacturing method for a conductive cover plate according to the present invention is applied to any of the above-mentioned microfluidic chips. The method includes the following steps: coating a first hydrophobic layer on a conductive cover plate, mounting the conductive cover plate coated with the first hydrophobic layer on a fixing jig, and erasing the first hydrophobic layer corresponding to the surface of amplification region by using an erasing tool.

In a further solution, hydrophilic treatment is performed on the surface of the amplification region from which the first hydrophobic layer has been erased.

In a further solution, the fixing jig exposes only the amplification region from the conductive cover plate.

To achieve the above-mentioned fifth objective, the present invention provides the usage method for the microfluidic chip for the above-mentioned first objective. The method includes: controlling, by a magnetic apparatus, to-be-tested sample droplets with magnetic beads to sequentially pass through a lysis chamber and a washing chamber and then move into an elution chamber, controlling, by the magnetic apparatus, the magnetic beads to reciprocate between a storage chamber and the elution chamber, and energizing an electrode array to cause the sample droplets in the elution chamber to enter a liquid storage chamber.

To achieve the above-mentioned sixth objective, the microfluidic system according to the present invention is a microfluidic system including the above-mentioned microfluidic chip. The system further includes a driving circuit and a control terminal, where the control terminal is electrically connected to the driving circuit, and the control terminal is configured to send a control instruction to the driving circuit; and the driving circuit is electrically connected to an electrode array, and the driving circuit is used to control the change of the energized state of the electrode array.

In a further solution, the microfluidic system further includes a magnetic apparatus and a fluorescence detection apparatus, where the magnetic apparatus is used to control a sample to move in the extraction assembly; and the fluorescence detection apparatus is used to detect the result of amplification of the sample in the amplification region.

### Beneficial Effects

A peripheral wall of the cavity of the microfluidic chip according to the present invention has a thickness of 0.6 mm to 2 mm. Since an eluent without a surfactant has a high surface tension, blocked by a side wall of the cavity, the eluent cannot enter the liquid storage chamber and the storage chamber, so that there is no need to separate the liquid storage chamber from the elution chamber by using a barrier such as a paraffin valve, thereby facilitating operation and production. The electrode array is arranged below the elution chamber, so that all the liquid in the elution chamber can enter the liquid storage chamber through an electrowetting effect. Therefore, the operation is convenient, and multiple refined operations can be completed.

According to the present invention, sample droplets can move more conveniently and smoothly from the elution chamber into the liquid storage chamber through the arranged first transition electrode, thereby preventing the sample droplets from being unable to move or incompletely move into the liquid storage chamber due to the dual effects of the blockage of the peripheral wall of the elution chamber and the gap between electrodes.

According to the present invention, the area of the current first liquid storage electrode is greater than that of the previous first liquid storage electrode, so that the liquid storage chamber can fully temporarily store the to-be-tested sample droplets, thereby meeting requirements for detection of a large volume of samples.

According to the present invention, the width between the first side edge and the second side edge of the current first liquid storage electrode is greater than that of the previous first liquid storage electrode, so that the volume of the chip can be effectively reduced, and the structure can be more compact.

According to the present invention, the first side edges of all the first liquid storage electrodes are collinearly arranged, and the second side edges of all the first liquid storage electrodes are collinearly arranged, so that the sample droplets move faster.

According to the present invention, through the first arc-shaped portion, the first arc-shaped segment, the second arc-shaped portion, and the second arc-shaped segment that are arranged, the sample droplets move more smoothly between two adjacent electrodes.

According to the present invention, the first electrode and the second electrode are arranged in parallel in the width direction of the liquid separation portion, so that when one of the electrodes remains energized, a volume of sample droplets on the liquid separation electrode region can be effectively reduced, thereby ensuring that the electrode droplets do not suddenly split or break up; or when the liquid separation region electrodes are not energized, the sample droplets can quickly split, and sizes of the split droplets are more precise, thereby meeting experimental requirements.

According to the present invention, when the liquid separation portion is directly adjacent to the second liquid storage electrode and liquid separation is performed, the second liquid storage electrode obtains more droplets, thereby affecting the volume of sample droplets obtained on the liquid fixation electrode. In this solution, the arranged transportation portion can increase the length of the liquid separation electrode region, so that the droplets are split more evenly and precisely.

According to the present invention, the width direction of the liquid fixation electrode is perpendicular to the width direction of the transportation electrode, so that the electrode array is arranged more properly, and the size of the microfluidic chip is effectively reduced.

According to the present invention, the area size of each liquid fixation electrode is designed, so that the required area size of the sample droplets is calculated as required. Therefore, a number of liquid fixation electrodes covered by the sample droplets is controlled, thereby obtaining sample droplets with a more precise size. Two adjacent liquid fixation electrodes have second arc-shaped edge portions with openings facing the liquid separation electrode region. This can accelerate the movement of the sample droplets located on the liquid fixation electrodes in a direction from the liquid separation electrode region to the liquid fixation electrode region. There are two or more second liquid storage electrodes, and two adjacent second liquid storage electrodes have first arc-shaped edge portions that are embedded with each other and that have openings facing the liquid separation electrode region, so that the movement of the sample droplets located in the second liquid storage electrode region in the direction from the liquid separation electrode region to the second liquid storage electrode region can be accelerated. In this way, a plurality of second liquid storage electrodes are energized during liquid separation, thereby accelerating the splitting of the sample droplets.

According to the present invention, the first arc-shaped edge portion is internally provided with the third arc-shaped edge portion with an opening facing away from the liquid separation electrode region, so that the sample droplets located in the second liquid storage electrode region move more smoothly. The second arc-shaped edge portion is internally provided with the fourth arc-shaped edge portion with an opening facing away from the liquid separation electrode region, so that the sample droplets located in the liquid fixation electrode region move more smoothly.

According to the present invention, the area of the first electrode is greater than that of the second electrode, so that when the first electrode is powered off and the second electrode remains energized, fewer sample droplets are located on the second electrode, and after the second electrode is powered off, the sample droplets located on the second electrode can split rapidly.

According to the present invention, the shape of the second electrode is an isosceles triangle, so that the sample droplets split more evenly.

According to the present invention, transition electrodes are arranged on two sides of the transportation electrode adjacent to the second liquid storage electrode, so that when the sample droplets move from the second liquid storage electrode to the transportation electrode, the droplets are prevented from moving and covering an exterior of the transportation electrode, and the movement of the sample droplets can be fully controlled.

According to the present invention, the first toothed portion, the second toothed portion, and the third toothed portion are arranged, so that the sample droplets sequentially move through the transportation electrode, the liquid separation electrode, and the liquid fixation electrode more smoothly.

Since an aqueous reagent and the to-be-tested sample have strong wettability on a hydrophilic surface, the reagent has a strong adsorption effect to the hydrophilic surface. According to the present invention, the conductive cover plate provided with the hydrophilic layer has a good aerophobic effect, and the aqueous reagent and the to-be-tested sample are more fully diffused in the amplification region. The chip substrate is coated with the first hydrophobic coating, so that the generation of bubbles can be reduced or even avoided during the amplification reaction, and the bubbles generated by the aqueous reagent and the to-be-tested sample can be quickly discharged after the chip substrate is heated. This prevents continuous evaporation of the reagent, which otherwise affects observation. The second hydrophobic layer arranged in the liquid path region surrounds the hydrophilic layer, so that the reagent can stably undergo an amplification reaction in the amplification region, and the reagent is prevented from being pushed away by the generated bubbles, which otherwise affects observation.

According to the present invention, the glue is mixed with the plastic beads with a specified diameter, so that while the glue achieves sealing and bonding effects, a height between two planes can be accurately limited. Compared with a method of limiting a height by using a gasket, glue, and the like in a conventional process, this solution reduces machining difficulty and shortens machining duration.

According to the present invention, the density of the plastic beads is close to that of the glue, so that the plastic beads can be evenly dispersed in the glue, thereby avoiding uneven sedimentation of particles.

According to the present invention, the extraction assembly and the amplification assembly are combined, so that an operation process can be effectively simplified. Reagents prestored in different chambers in the extraction assembly can be effectively separated by using the paraffin valves, so that contamination of different reagents is prevented. The volume of the microfluidic chip can be effectively reduced by arranging the heating wire in the substrate plate.

According to the present invention, hydrophilic treatment is performed where corresponding to the surface of the amplification region from which the hydrophobic coating has been erased, so that hydrophilicity of the amplification region can be effectively improved.

According to the present invention, through reciprocation of the magnetic beads, the surfactant in the storage chamber is fully and evenly mixed with the sample droplets, so that the surface tension of the sample droplets is reduced, thereby facilitating movement of the sample droplets.

To sum up, the microfluidic chip according to the present invention can reduce the risk of bubbles generated in the PCR process, and the sample reagents in the amplification region can exist stably, which facilitates observation. The chip has a simple and compact structure, stores the eluent easily, with a larger capacity, and can increase detection efficiency, to cause the sample droplets in the elution chamber to fully move into the liquid path chamber. During liquid separation, even splitting of the sample droplets can be controlled, and the size of split sample droplets can be controlled precisely.

### BRIEF DESCRIPTION OF THE DRAWINGS

FIG. 1 is a structural diagram of a microfluidic chip from a first perspective according to an embodiment of the present invention;

FIG. 2 is a structural diagram of division of a conductive cover plate of a microfluidic chip into a liquid path region and an amplification region from a second perspective according to an embodiment of the present invention;

FIG. 3 is a structural diagram of division of chamber body regions of a microfluidic chip from a second perspective according to an embodiment of the present invention;

FIG. 4 is a sectional view of an amplification assembly of a microfluidic chip according to an embodiment of the present invention;

FIG. 5 is a sectional view of an extraction assembly of a microfluidic chip according to an embodiment of the present invention;

FIG. 6 is a state diagram of a to-be-tested sample located between two hydrophobic layers in an amplification region of an existing microfluidic chip;

FIG. 7 is a state diagram of a to-be-tested sample located in an amplification region of a microfluidic chip according to an embodiment of the present invention;

FIG. 8 is a partial sectional view of a microfluidic chip including an elution chamber, a first channel, and a liquid path chamber according to an embodiment of the present invention;

FIG. 9 is a partial sectional view of a microfluidic chip including an elution chamber and a storage chamber according to an embodiment of the present invention;

FIG. 10 is a schematic plan view of an elution electrode region and a first liquid storage electrode region of a microfluidic chip according to an embodiment of the present invention;

FIG. 11 is a schematic plan view of an electrode array according to an embodiment of the present invention;

FIG. 12 is an enlarged view of a part A of FIG. 11;

FIG. 13 is a first state diagram of sample droplets on an electrode array according to an embodiment of the present invention;

FIG. 14 is a second state diagram of sample droplets on an electrode array according to an embodiment of the present invention;

FIG. 15 is a third state diagram of sample droplets on an electrode array according to an embodiment of the present invention;

FIG. 16 is a fourth state diagram of sample droplets on an electrode array according to an embodiment of the present invention; and

FIG. 17 is a structural block diagram of a microfluidic system according to an embodiment of the present invention.

### DETAILED DESCRIPTION OF THE EMBODIMENTS

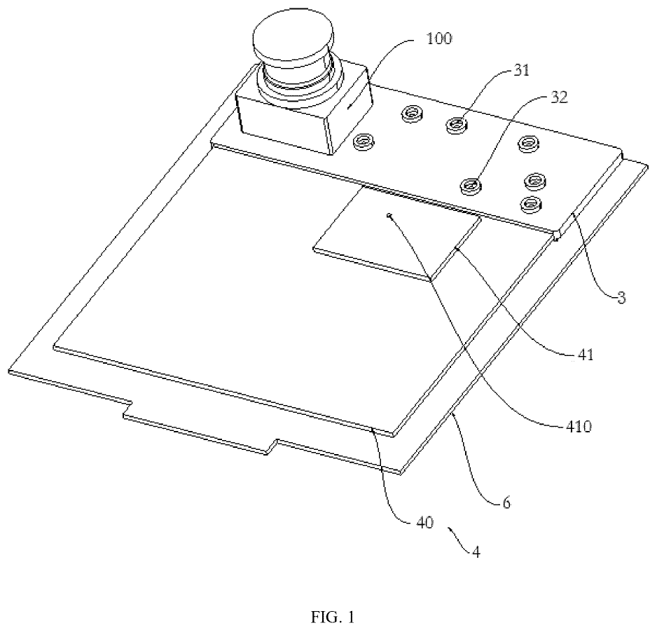

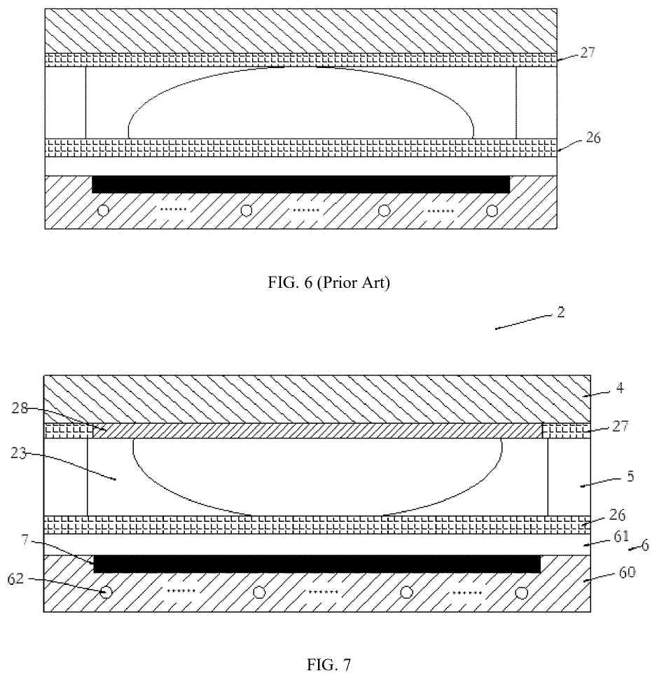

Referring to FIG. 1 to FIG. 7, a microfluidic chip 304 of this embodiment includes an extraction cover plate 3, a conductive cover plate 4, a barrier layer 5, and a chip substrate 6. The extraction cover plate 3 is adjacent to the conductive cover plate 4, and both the conductive cover plate 4 and the extraction cover plate 3 are arranged opposite to the chip substrate 6. The extraction cover plate 3 is combined with the chip substrate 6 to form an extraction assembly 1, and the extraction assembly 1 includes a lysis chamber 100, a first valve chamber 101, a first washing chamber 102, a second washing chamber 103, and a second valve chamber 104 that sequentially connect with each other. The first valve chamber 101 and the second valve chamber 104 are filled with paraffin. The barrier layer 5, the chip substrate 6, and the conductive cover plate 4 are combined to form an amplification assembly 2. The barrier layer 5 is located between the conductive cover plate 4 and the chip substrate 6. The barrier layer 5, the chip substrate 6, and the conductive cover plate 4 form an accommodating portion 10. The accommodating portion 10 includes a storage chamber 20, an elution chamber 21, a liquid path chamber 22, and an amplification chamber 23 that sequentially connect with each other. The elution chamber 21 connects with the second valve chamber 104 through a first channel 24. Optionally, there is at least one washing chamber. The chip substrate 6 includes a substrate plate 60, an electrode array 7, and an insulating layer 61. The electrode array 7 is located on the substrate plate 60, and the insulating layer 61 covers the electrode array 7 and is adjacent to the conductive cover plate 4. The electrode array 7 is arranged corresponding to the accommodating portion 10.

The amplification assembly 2 further includes a first hydrophobic layer 26, a hydrophilic layer 28, and a second hydrophobic layer 27. The first hydrophobic layer 26 is located on a side of the insulating layer 61 adjacent to the conductive cover plate 4. The conductive cover plate 4 includes a liquid path region 42 and an amplification region 43 that are connected to each other. The liquid path region 42 corresponds to the liquid path chamber 22, and the amplification region 43 corresponds to the amplification chamber 23. The hydrophilic layer 28 is located on a side of the amplification region 43 adjacent to the chip substrate 6, and the hydrophilic layer 28 is arranged opposite to the first hydrophobic layer 26. A side of the liquid path region 42 adjacent to the chip substrate 6 is coated with the second hydrophobic layer 27, and the hydrophilic layer 28 is adjacent to the second hydrophobic layer 27.

Since the amplification region 43 is surrounded by hydrophobic layers, a sample reagent can be in stable contact with the hydrophilic layer 28, so that the sample reagent is not pushed away by generated bubbles. Moreover, since a hydrophobic layer is provided on a side of the chip substrate 6 opposite to the amplification region 43, an area of the sample reagent in contact with the hydrophobic layer is smaller than that of the hydrophilic layer 28, so that the generation of the bubbles can be reduced or even avoided, and the generated bubbles can be quickly discharged.

This embodiment further provides a manufacturing method for a conductive cover plate 4. The method is used for manufacturing the above-mentioned microfluidic chip 304. A first hydrophobic layer 26 is coated on a conductive cover plate 4 first, and the conductive cover plate 4 coated with the first hydrophobic layer 26 is arranged on a fixing jig (not shown in the figure). The fixing jig exposes only the amplification region 43 from the conductive cover plate 4. The first hydrophobic layer 26 where corresponding to the surface of the amplification region 43 is erased by using an erasing tool such as a cotton swab. Optionally, to further improve hydrophilicity of ITO glass, a hydrophilic coating is coated on the surface of the amplification region 43 from which the hydrophobic coating has been erased, or hydrophilic treatment is performed on the surface of the amplification region 43 by using a method such as laser, etching or plasma.

A heating unit 62 is arranged in the substrate plate 60, and the heating unit 62 includes first heating wires (not shown in the figure) and a second heating wire (not shown in the figure). The first heating wires are correspondingly arranged right under the first valve chamber 101 and the second valve chamber 104, and the second heating wire is located right under the amplification chamber 23. The insulating layer 61 may be a dielectric layer.

The barrier layer 5 includes a mixture, and the mixture is formed by mixing glue and plastic beads. A density of the glue is close to that of the plastic beads. For example, a ratio of the density of the glue to the density of the plastic beads is greater than or equal to 95%. Optionally, the barrier layer 5 includes a gasket (not shown in the figure) and glue (not shown in the figure). A distance between the conductive cover plate 4 and the chip substrate 6 is equal to a diameter of each plastic bead.

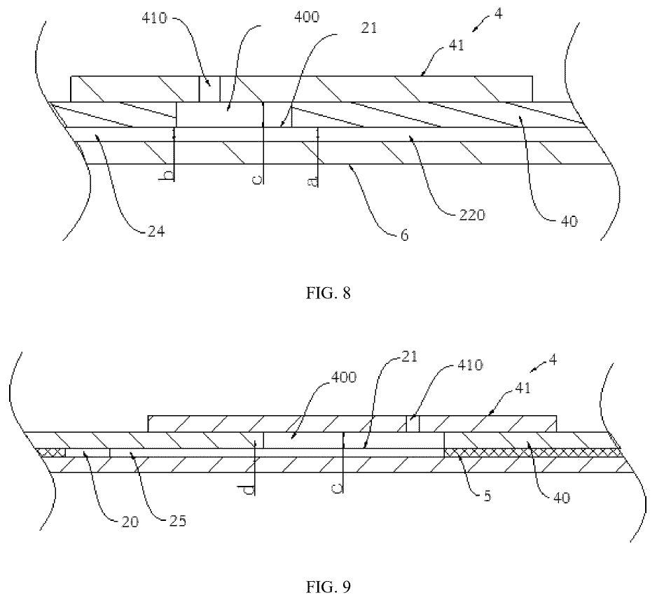

With reference to FIG. 8 and FIG. 9, the conductive cover plate 4 may be made of ITO glass. The conductive cover plate 4 includes a plate body 40 and a cover body 41. The plate body 40 is provided with a cavity 400 having openings at both a bottom and a top. The bottom opening of the cavity 400 is located on a side of the plate body 40 adjacent to the chip substrate 6, and the top opening of the cavity 400 is located on a side of the plate body 40 facing away from the chip substrate 6. The cover body 41 covers the top opening of the cavity 400, and the elution chamber 21 contains the cavity 400. Optionally, the cover body 41 is integrally formed with the plate body 40.

The extraction cover plate 3 is provided with a first sample loading hole 30, a second sample loading hole 31, and a third sample loading hole 32. The first sample loading hole 30 connects with the lysis chamber 100, the second sample loading hole 31 connects with the first washing chamber 102, and the third sample loading hole 32 connects with the second washing chamber 103. The cover body 41 is provided with a fourth sample loading hole 410, and the fourth sample loading hole 410 connects with the elution chamber 21. A lysis solution is prestored in the lysis chamber 100, washing solutions are prestored in the first washing chamber 102 and the second washing chamber 103, and an eluent is prestored in the elution chamber 21. Heating wires (not shown in the figure) are arranged on the chip substrate 6 at positions corresponding to the first valve chamber 101 and the second valve chamber 104, and are configured to melt paraffin inside the first valve chamber 101 and the second valve chamber 104. The electrode array 7 is located right under the elution chamber 21, the liquid path chamber 22, and the amplification chamber 23.

A surfactant (not shown in the figure) is prestored in the storage chamber 20, and the solidified surfactant may be prestored in the storage chamber 20 through freeze-drying or drying. The storage chamber 20 connects with the elution chamber 21 through a second channel 25, and the liquid path chamber 22 includes a liquid storage chamber 220 and a liquid separation chamber body 221 that are sequentially arranged in a direction from the liquid path chamber 22 to the amplification chamber 23. The liquid storage chamber 220 is adjacent to the elution chamber 21, and the liquid separation chamber body 221 is adjacent to the amplification chamber 23. The cavity 400 has a thickness c of 0.6 mm to 2 mm in a thickness direction of the microfluidic chip 304. A distance b between a top wall of the first channel 24 and an upper surface of the chip substrate 6 is less than 7 mm and greater than or equal to 4 mm. A distance d between a top wall of the second channel 25 and the upper surface of the chip substrate 6 is less than 7 mm and greater than or equal to 4 mm. A distance a between a top wall of the liquid storage chamber 220 and the upper surface of the chip substrate 6 is less than 7 mm and greater than or equal to 4 mm.

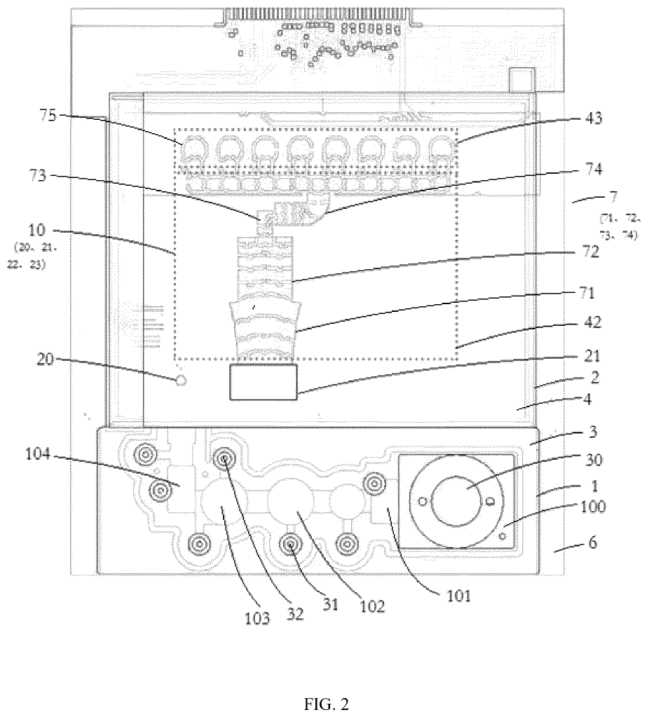

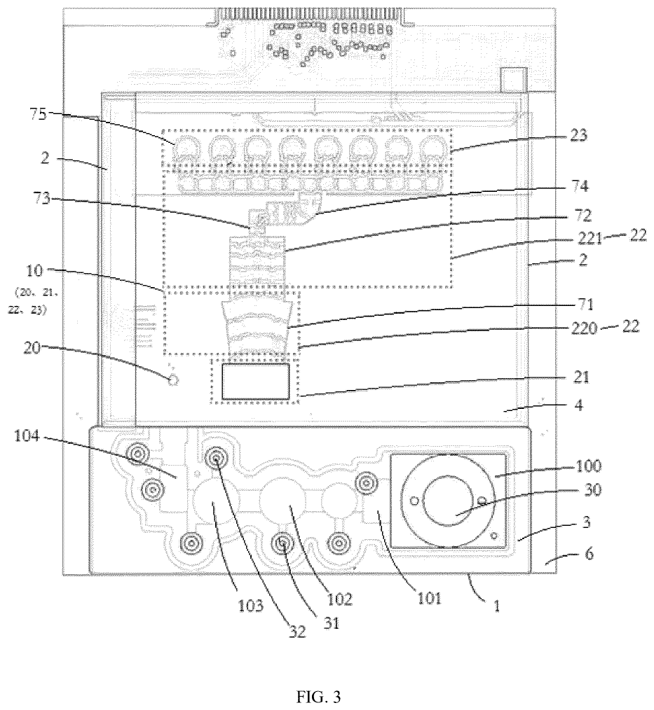

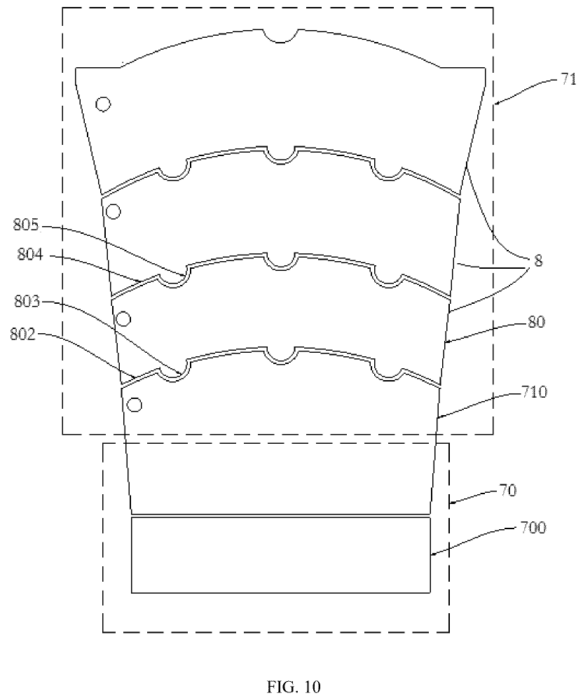

Referring to FIG. 2 and FIG. 3 and with reference to FIG. 10, the electrode array 7 includes an elution electrode region 70, a first liquid storage electrode region 71, a second liquid storage electrode region 72, a liquid separation electrode region 73, a liquid fixation electrode region 74, and an amplification electrode region 75 that are sequentially adjacent to each other. Viewing on the projection of the chip substrate 6, the elution electrode region 70 is located in the elution chamber 21, and the first liquid storage electrode region 71, the second liquid storage electrode region 72, the liquid separation electrode region 73, and the liquid fixation electrode region 74 are located in the liquid path chamber 22. The amplification electrode region 75 is located in the amplification chamber 23. The elution electrode region 70 includes an elution electrode 700. The first liquid storage electrode region 71 includes a first transition electrode 710 and a first liquid storage electrode group 8 that are adjacent to each other. Viewing on the projection of the chip substrate 6. The first transition electrode 710 spans across the elution chamber 21 and the liquid storage chamber 220, and the first transition electrode 710 is located between the elution electrode region 70 and the first liquid storage electrode group 8. The first liquid storage electrode group 8 is located in the liquid storage chamber 220. Optionally, the elution electrode region 70 includes one or more elution electrodes 700, and a plurality of elution electrodes 700 are sequentially arranged in a direction from the elution chamber 21 to the liquid path chamber 22.

The first liquid storage electrode group 8 includes three first liquid storage electrodes 80, and the three first liquid storage electrodes 80 are sequentially arranged in a direction from the elution chamber 21 to the liquid path chamber 22. An area of a current first liquid storage electrode 80 is greater than that of a previous first liquid storage electrode 80, and the previous first liquid storage electrode 80 is closer to the first transition electrode 710 than the current first liquid storage electrode 80. Each first liquid storage electrode 80 includes a first side edge and a second side edge that extend in a direction from the elution chamber 21 to the liquid path chamber 22, the first side edge and the second side edge are opposite to each other, and a width between the first side edge and the second side edge of the current first liquid storage electrode is greater than that between the first side edge and the second side edge of the previous first liquid storage electrode. The first side edges of all the first liquid storage electrodes are collinearly arranged, and the second side edges of all the first liquid storage electrodes are collinearly arranged. Optionally, there are two or more first liquid storage electrodes 80.

The first transition electrode 710 and the first liquid storage electrode 80 adjacent to the first transition electrode 710 have first arc-shaped portions 802 that are embedded with each other, and an opening of each first arc-shaped portion 802 faces the first transition electrode 710; and two adjacent first liquid storage electrodes 80 have second arc-shaped portions 804 that are embedded with each other, and an opening of each second arc-shaped portion 804 faces the first transition electrode 710. Three first arc-shaped segments 803 are spaced apart in the first arc-shaped portion 802, and an opening of each first arc-shaped segment 803 faces away from the first transition electrode 710; and three second arc-shaped segments 805 are arranged in the second arc-shaped portion 804, and an opening of each second arc-shaped segment 805 faces away from the first transition electrode 710. Optionally, there is at least one first arc-shaped segment 803, and there is at least one second arc-shaped segment 805.

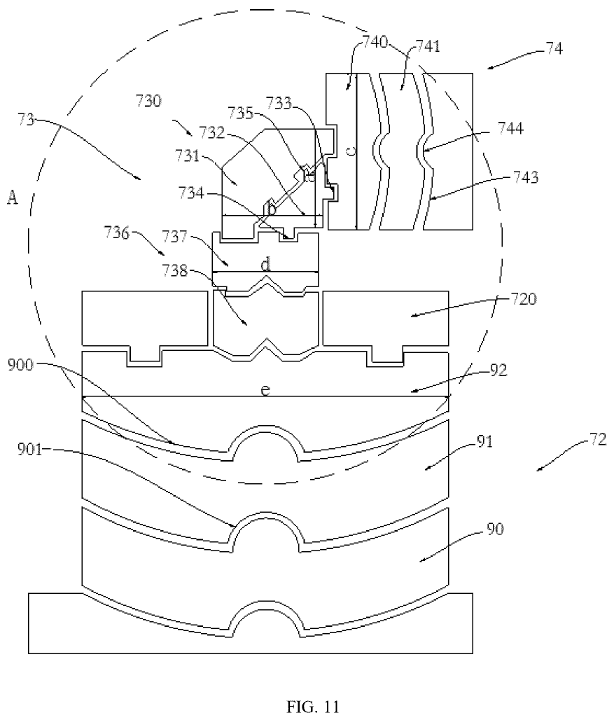

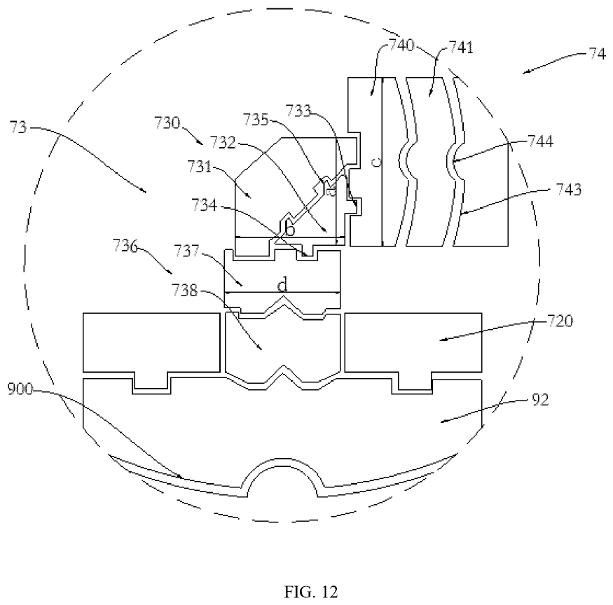

With reference to FIG. 11 and FIG. 12, the liquid fixation electrode region 74 includes a liquid fixation electrode 740 and a liquid fixation electrode 741 that are sequentially adjacent to each other, and the second liquid storage electrode region 72 includes a second liquid storage electrode 90, a second liquid storage electrode 91, and a second liquid storage electrode 92 that are sequentially adjacent to each other. Optionally, the number of liquid fixation electrodes and the number of second liquid storage electrodes are determined based on design requirements. The liquid separation electrode region 73 includes a liquid separation portion 730 and a transportation portion 736, and the transportation portion 736 is located between the liquid separation portion 730 and the second liquid storage electrode 92. The liquid separation portion 730 includes a first electrode 731 and a second electrode 732 that are arranged in parallel in a width direction of the liquid separation portion 730. An area of the second electrode 732 is less than that of the first electrode 731, and widths a and b of the liquid separation electrode region 73 are both less than a width c of the liquid fixation electrode region 74. A width e of the second liquid storage electrode region 72 is greater than the width c of the liquid fixation electrode region 74.

A width direction c of the liquid fixation electrode region 74 is perpendicular to a width direction d of the transportation portion 736, and a width direction b of a first end of the liquid separation portion 730 is parallel to the width direction d of the transportation portion 736. The first end of the liquid separation portion 730 is adjacent to the transportation portion 736, and a width direction a of a second end of the liquid separation portion 730 is parallel to a width direction c of the liquid fixation electrode region 74. The second end of the liquid separation portion 730 is adjacent to the liquid fixation electrode region 74. A shape of the second electrode 732 includes an isosceles triangle. A hypotenuse of the second electrode 732 is adjacent to the first electrode 731, and the transportation portion 736 and the liquid fixation electrode region 74 are adjacent to two right-angled sides of the second electrode 732, respectively. Optionally, the shape of the second electrode 732 may be a triangle, a square, or the like.

In this embodiment, the second liquid storage electrode 91 and the second liquid storage electrode 92 that are adjacent to each other have first arc-shaped edge portions 900 that are embedded with each other therebetween, and an opening of each first arc-shaped edge portion 900 faces the liquid separation electrode region 73. The liquid fixation electrode 740 and the liquid fixation electrode 741 that are adjacent to each other have second arc-shaped edge portions 743 that are embedded with each other therebetween, and an opening of each second arc-shaped edge portion 743 faces the liquid separation electrode region 73. A third arc-shaped edge portion 901 is arranged in the first arc-shaped edge portion 900, and an opening of the third arc-shaped edge portion 901 faces away from the liquid separation electrode region 73. A fourth arc-shaped edge portion 744 is arranged in the second arc-shaped edge portion 743, and an opening of the fourth arc-shaped edge portion 744 faces away from the liquid separation electrode region 73. Optionally, there may be one or more third arc-shaped edge portions 901, and there may be one or more fourth arc-shaped edge portions 744.

The second liquid storage electrode region 72 further includes two second transition electrodes 720. The transportation portion 736 includes a transportation electrode 737 and a transportation electrode 738 that are sequentially adjacent to each other in a length direction of the transportation portion 736. The transportation electrode 738 adjacent to the second liquid storage electrode is located between the two second transition electrodes 720, and each second transition electrode 720 is adjacent to both the second liquid storage electrode 92 and the transportation electrode 738.

The liquid separation portion 730 includes a first toothed portion 733, a second toothed portion 734, and a third toothed portion 735. The first toothed portion 733 is located at an edge of the liquid separation portion 730 adjacent to the liquid fixation electrode region 74 and is embedded in the edge of the liquid fixation electrode region 74. The second toothed portion 734 is located at an edge of the liquid separation portion 730 adjacent to the transportation portion 736 and is embedded in the edge of the transportation portion 736. The third toothed portion 735 is located at an edge of the second electrode 732 adjacent to the first electrode 731 and is embedded in the first electrode 731.

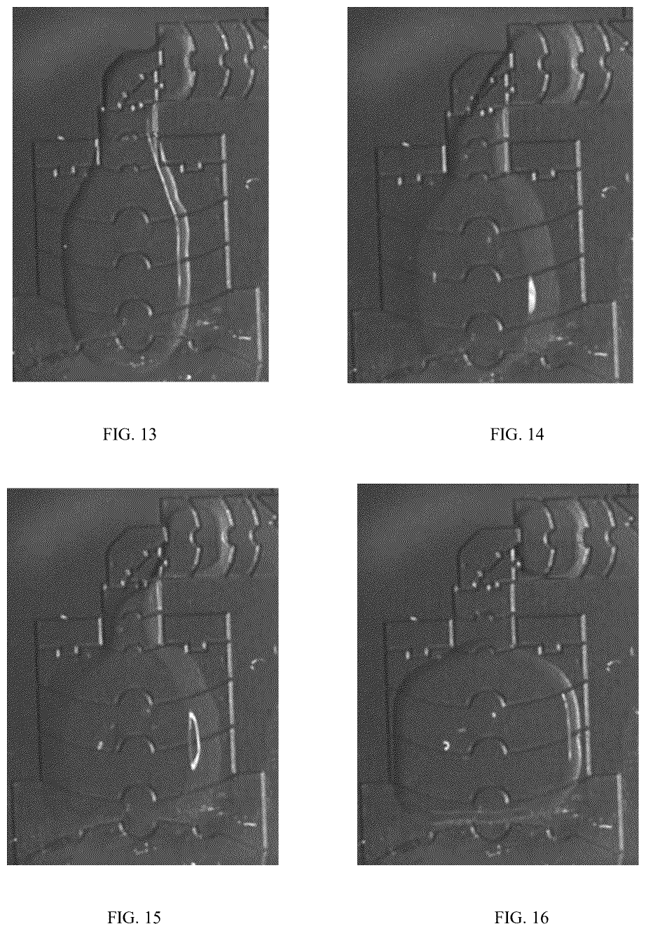

With reference to FIG. 13 to FIG. 16, this embodiment further provides a control method for the above-mentioned electrode array 7 when sample droplets are separated:

Sample mother droplets cover the second liquid storage electrode 92. In this case, the transportation portion 736, the liquid separation portion 730, and the liquid fixation electrode 740 are energized, and the sample mother droplets move onto the liquid fixation electrode 740.

Then, the liquid fixation electrode 740, the liquid fixation electrode 741, the second electrode 732, and the transportation electrode are energized, and the sample mother droplets gradually move onto the liquid fixation electrode 741. Since the first electrode 731 is not energized, whereas the second electrode 732 is energized, the sample mother droplets on the liquid separation portion 730 are reduced but are not split.

Then, the liquid fixation electrode 740, the liquid fixation electrode 741, the transportation electrode 737, the transportation electrode 738, the second liquid storage electrode 92, the second liquid storage electrode 91, and the liquid storage electrode 90 are energized, and the liquid separation portion 730 is powered off, so that the liquid fixation electrode 741 and the liquid fixation electrode 740 fix sizes of split sample daughter droplets, whereas the sample mother droplets move toward large electrodes when the transportation electrode 737, the transportation electrode 738, the second liquid storage electrode 92, the second liquid storage electrode 91, and the second liquid storage electrode 90 are energized. Droplets in the liquid separation portion 730 gradually decrease, and the sample daughter droplets are separated from the sample mother droplets.

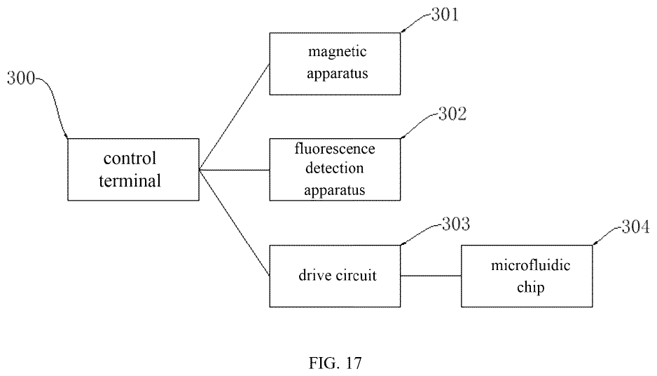

With reference to FIG. 17, this embodiment further provides a microfluidic system including the above-mentioned microfluidic chip 304. The system includes a control terminal 300, a magnetic apparatus 301, a fluorescence detection apparatus 302, and a driving circuit 303. The control terminal 300 is electrically connected to the electrode array 7 through the driving circuit 303, and the control terminal 300 sends a control instruction to the driving circuit 303. The driving circuit 303 is electrically connected to the electrode array 7. The driving circuit 303 is configured to control an energized state of the electrode array 7. The control terminal 300 controls movement of the magnetic apparatus 301, thereby controlling a to-be-tested sample with magnetic beads and a reagent to move in an extraction assembly 1, and the fluorescence detection apparatus 302 is configured to detect a result of amplification of the to-be-tested sample in an amplification region 43.

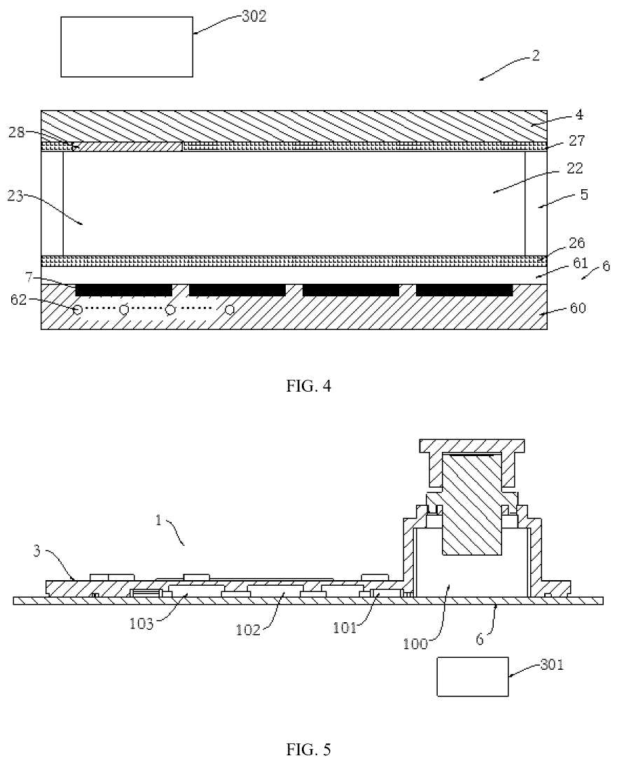

With reference to FIG. 4 and FIG. 5, this embodiment further provides a usage method for the above-mentioned microfluidic chip 304. A magnetic apparatus 301 (not shown in the figure) controls a to-be-tested sample (not shown in the figure) with magnetic beads to sequentially pass through a lysis chamber 100 and a washing chamber and then move into an elution chamber 21. Then the magnetic apparatus 301 controls the magnetic beads to reciprocate between a storage chamber 20 and the elution chamber 21, so that a surfactant and droplets of the to-be-tested sample are fully and evenly mixed. Then an electrode array 7 is energized to cause the sample droplets to enter a liquid storage chamber 220 from the elution chamber 21.

It should be noted that the above are only preferred embodiments of the present invention, but the design concept of the present invention is not limited thereto. Any non-substantial modifications made to the present invention by using this concept also fall within the protection scope of the present invention.

### Industrial Applicability

In the microfluidic chip and the usage method therefor, the microfluidic system, and the manufacturing method for a conductive cover plate according to the present invention, the risk of bubbles generated in a PCR process can be reduced through modification of a surface coating of the conductive cover plate, and a sample reagent in the amplification region can exist stably, which facilitates observation. The chip has a simple and compact structure. Through optimization of a specific chamber body dimension, the process can be simplified, and costs can be reduced. Through optimization of the structure and arrangement manner of the electrode array, the eluent can be stored easily, with a larger capacity, and detection efficiency can be increased, to cause the sample droplets in the elution chamber to fully move into the liquid path chamber. During liquid separation, even splitting of the sample droplets can be controlled, and the size of split sample droplets can be controlled precisely.

What is claimed is:

1-28. (canceled)

29. A microfluidic chip, comprising an extraction assembly and an amplification assembly, wherein the extraction assembly comprises a lysis chamber, a first valve chamber, a washing chamber and a second valve chamber, and the lysis chamber, the first valve chamber, the washing chamber and the second valve chamber sequentially connect with each other;
the amplification assembly comprises a chip substrate, a barrier layer, and a conductive cover plate;
the barrier layer is located between the chip substrate and the conductive cover plate; the barrier layer, the chip substrate and the conductive cover plate form an elution chamber, a liquid path chamber and an amplification chamber, wherein the elution chamber, the liquid path chamber and the amplification chamber sequentially connect with each other; and the elution chamber connects with the second valve chamber through a first channel;
an electrode array is arranged on the chip substrate;
a side of the conductive cover plate adjacent to the chip substrate is provided with a cavity having an opening at a bottom, and the elution chamber contains the cavity;
the electrode array is located right under the elution chamber, the liquid path chamber, and the amplification chamber;
the amplification assembly further comprises a storage chamber for storing a surfactant, and the storage chamber connects with the elution chamber through a second channel;
the liquid path chamber comprises a liquid storage chamber, and the liquid storage chamber is adjacent to the elution chamber; and
the cavity has a thickness of 0.6 mm to 2 mm in a thickness direction of the microfluidic chip.

30. The microfluidic chip according to claim 29, wherein
the electrode array comprises an elution electrode region and a first liquid storage electrode region adjacent to each other, wherein the elution electrode region comprises at least one elution electrode, and viewing on a projection of the chip substrate, the at least one elution electrode is located in the elution chamber; and
the first liquid storage electrode region comprises a first transition electrode and a first liquid storage electrode group adjacent to each other, wherein viewing on the projection of the chip substrate, the first transition electrode spans across both the elution chamber and the liquid storage chamber, the first transition electrode is located between the elution electrode region and the first liquid storage electrode group, and the first liquid storage electrode group is located in the liquid storage chamber.

31. The microfluidic chip according to claim 30, wherein
the first liquid storage electrode group comprises a plurality of first liquid storage electrodes, the plurality of first liquid storage electrodes are sequentially arranged in a direction from the elution chamber to the liquid path chamber, an area of a current first liquid storage electrode is greater than an area of a previous first liquid storage electrode, and the previous first liquid storage electrode is closer to the first transition electrode than the current first liquid storage electrode.

32. The microfluidic chip according to claim 31, wherein
each first liquid storage electrode of the plurality of first liquid storage electrodes comprises a first side edge and a second side edge, wherein the first side edge and the second side edge extend in a direction from the elution chamber to the liquid path chamber, the first side edge and the second side edge are opposite to each other, and a width between the first side edge and the second side edge of the current first liquid storage electrode is greater than a width between the first side edge and the second side edge of the previous first liquid storage electrode.

33. The microfluidic chip according to claim 32, wherein
the first side edges of all the plurality of first liquid storage electrodes are collinearly arranged, and the second side edges of all the plurality of first liquid storage electrodes are collinearly arranged.

34. A microfluidic chip, comprising an amplification assembly, wherein the amplification assembly comprises a chip substrate, a barrier layer, and a conductive cover plate;
the chip substrate is arranged opposite to the conductive cover plate;
the chip substrate comprises a substrate plate, an electrode array, and an insulating layer, wherein the electrode array is located on the substrate plate, and the insulating layer covers the electrode array and is adjacent to the conductive cover plate;
the barrier layer is located between the chip substrate and the conductive cover plate, an accommodating portion is formed among the barrier layer, the chip substrate and the conductive cover plate, and the electrode array corresponds to the accommodating portion;
the electrode array comprises a second liquid storage electrode region, a liquid separation electrode region and a liquid fixation electrode region, wherein the second liquid storage electrode region, the liquid separation electrode region and the liquid fixation electrode region are sequentially adjacent to each other;
a width of the liquid fixation electrode region and a width of the second liquid storage electrode region are greater than a width of the liquid separation electrode region;
the liquid fixation electrode region comprises at least one liquid fixation electrode;
the second liquid storage electrode region comprises at least one second liquid storage electrode;
the liquid separation electrode region comprises a liquid separation portion, and the liquid separation portion comprises a first electrode and a second electrode, wherein the first electrode and the second electrode are adjacently arranged in a width direction of the liquid separation portion; and
an area of the second electrode is less than an area of the at least one liquid fixation electrode.

35. The microfluidic chip according to claim 34, wherein
the liquid separation electrode region further comprises a transportation portion, the transportation portion comprises at least one transportation electrode, and the transportation portion is located between the liquid separation portion and the second liquid storage electrode region.

36. The microfluidic chip according to claim 35, wherein
a width direction of the at least one liquid fixation electrode intersects a width direction of the transportation portion, a width direction of a first end of the liquid separation portion is parallel to the width direction of the transportation portion, the first end of the liquid separation portion is adjacent to the transportation portion, a width direction of a second end of the liquid separation portion is parallel to a width direction of the liquid fixation electrode region, and the second end of the liquid separation portion is adjacent to the liquid fixation electrode region.

37. The microfluidic chip according to claim 36, wherein
the width direction of the liquid fixation electrode region is perpendicular to the width direction of the transportation portion.

38. The microfluidic chip according to claim 34, wherein
the second liquid storage electrode region comprises two or more sequentially adjacent second liquid storage electrodes, two adjacent second liquid storage electrodes have first arc-shaped edge portions embedded with each other, and an opening of each of the first arc-shaped edge portions faces the liquid separation electrode region; and
the liquid fixation electrode region comprises two or more sequentially adjacent liquid fixation electrodes, two adjacent liquid fixation electrodes have second arc-shaped edge portions embedded with each other, and an opening of each of the second arc-shaped edge portions faces the liquid separation electrode region.

39. The microfluidic chip according to claim 38, wherein
the liquid separation portion comprises a first toothed portion, a second toothed portion, and a third toothed portion;
the first toothed portion is located at an edge of the liquid separation portion adjacent to the liquid fixation electrode region and is embedded in an edge of the liquid fixation electrode region;
the second toothed portion is located at an edge of the liquid separation portion adjacent to the transportation portion and is embedded in an edge of the transportation portion; and
the third toothed portion is located at an edge of the second electrode adjacent to the first electrode and is embedded in the first electrode.

40. A microfluidic chip, comprising an amplification assembly, wherein the amplification assembly comprises a chip substrate, a conductive cover plate, a barrier layer, and a first hydrophobic layer;
the chip substrate is arranged opposite to the conductive cover plate;
the chip substrate comprises a substrate plate, an electrode array, and an insulating layer;
the first hydrophobic layer is located on a side of the insulating layer oriented towards the conductive cover plate;
the electrode array is located on the substrate plate, and the insulating layer covers the electrode array;
the barrier layer is located between the chip substrate and the conductive cover plate; a liquid path chamber and an amplification chamber connecting with each other are formed among the barrier layer, the chip substrate, and the conductive cover plate; and the liquid path chamber and the amplification chamber are arranged corresponding to the electrode array;
the conductive cover plate comprises a liquid path region and an amplification region connected to each other, the liquid path region corresponds to the liquid path chamber, and the amplification region corresponds to the amplification chamber;
the amplification assembly further comprises a second hydrophobic layer and a hydrophilic layer adjacent to each other;
the hydrophilic layer is located on a side of the amplification region adjacent to the chip substrate; and
the second hydrophobic layer is located on a side of the liquid path region adjacent to the chip substrate, and the second hydrophobic layer and the hydrophilic layer are arranged opposite to the first hydrophobic layer.

41. The microfluidic chip according to claim 40, wherein the barrier layer comprises a mixture of glue and plastic beads, and a distance between the chip substrate and the conductive cover plate is equal to a diameter of each of the plastic beads.

42. The microfluidic chip according to claim 41, wherein
a ratio of a density of the glue to a density of the plastic beads is greater than or equal to 95%.

43. The microfluidic chip according to claim 40, further comprising an extraction assembly and a heating unit, wherein
the extraction assembly connects with the amplification assembly;
the extraction assembly comprises a lysis chamber, a washing chamber and an elution chamber, wherein the lysis chamber, the washing chamber and the elution chamber sequentially connect with each other;
the lysis chamber, the washing chamber, and the elution chamber are separated through a paraffin valve; and
the heating unit is arranged in the chip substrate, and the heating unit comprises a first heating wire and a second heating wire, wherein the first heating wire and the second heating wire are arranged in the substrate plate, the first heating wire corresponds to the paraffin valve, and the second heating wire corresponds to the amplification chamber.

44. A manufacturing method for a conductive cover plate, applied to the microfluidic chip according to claim 40, comprising the following steps:
coating the first hydrophobic layer on the conductive cover plate, mounting the conductive cover plate coated with the first hydrophobic layer on a fixing jig, and erasing the first hydrophobic layer corresponding to a surface of the amplification region by using an erasing tool.

45. The manufacturing method for the conductive cover plate according to claim 44, wherein
hydrophilic treatment is performed on the surface of the amplification region from which the first hydrophobic layer has been erased.

46. A usage method for a microfluidic chip, applied to the microfluidic chip according to claim 29, comprising:
controlling, by a magnetic apparatus, to-be-tested sample droplets with magnetic beads to sequentially pass through the lysis chamber and the washing chamber and then move into the elution chamber, controlling, by the magnetic apparatus, the magnetic beads to reciprocate between the storage chamber and the elution chamber, and energizing the electrode array to cause the to-be-tested sample droplets in the elution chamber to enter the liquid storage chamber.

47. A microfluidic system, comprising: the microfluidic chip according to claim 29, a driving circuit and a control terminal; wherein
the control terminal is electrically connected to the driving circuit, and the control terminal is configured to send a control instruction to the driving circuit; and
the driving circuit is electrically connected to the electrode array, and the driving circuit is configured to control a change of an energized state of the electrode array.

48. The microfluidic system according to claim 47, further comprising a magnetic apparatus and a fluorescence detection apparatus, wherein
the magnetic apparatus is configured to control a sample to move in the extraction assembly, and the fluorescence detection apparatus is configured to detect a result of amplification of the sample in an amplification region.
